(19) United States
(12) Patent Application Publication
(10) Pub. No.: US 2021/0086539 A1
(43) Pub. Date: Mar. 25, 2021

(54) Ink Jet Recording Apparatus And Ink Jet Method

(71) Applicant: Seiko Epson Corporation, Tokyo (JP)

(72) Inventor: Yasuhiro OKI, Matsumoto (JP)

(21) Appl. No.: 17/024,848

(22) Filed: Sep. 18, 2020

(30) Foreign Application Priority Data
Sep. 19, 2019 (JP) 2019-170791

(51) Int. Cl. B41M 5/00; B41J 3/407

(52) U.S. Cl. CPC B41M 5/0023; B41J 3/4078

(57) ABSTRACT

An ink jet recording apparatus includes a textile printing ink composition and a liquid ejecting head including a nozzle that ejects the textile printing ink composition, where the textile printing ink composition contains an aqueous dye, an aqueous organic solvent, and water, a content of the aqueous dye with respect to a total amount of the textile printing ink composition is 10% by mass or more, and the liquid ejecting head includes the nozzle that ejects the textile printing ink composition, a pressure chamber to which the textile printing ink composition is supplied, and a circulation channel configured to circulate the textile printing ink composition supplied to the pressure chamber.

The present application is based on, and claims priority from JP Application Serial Number 2019-170791, filed Sep. 19, 2019, the disclosure of which is hereby incorporated by reference herein in its entirety.

### BACKGROUND

### 1. Technical Field

The present disclosure relates to an ink jet recording apparatus and an ink jet method.

### 2. Related Art

Ink jet recording methods enable high-definition image recording with a relatively simple apparatus, and have seen a rapid development in many fields. In this context, various studies have been conducted on image quality or the like. For example, JP-A-2017-110096 discloses an ink containing an acidic dye, two kinds of nonionic surfactants, and water to provide an acidic dye ink having high dye density and causing no dyeing unevenness and a method for textile printing a fiber using such an ink.

However, it has been found that when dye density is increased to improve the dye density, as described in JP-A-2017-110096, the content of a solvent in an ink is relatively decreased and that this causes a problem of the ink becoming prone to hardening and thus having poor recovery from clogging.

### SUMMARY

The present disclosure is an ink jet recording apparatus including a textile printing ink composition and a liquid ejecting head including a nozzle that ejects the textile printing ink composition, wherein the textile printing ink composition contains an aqueous dye, an aqueous organic solvent, and water, a content of the aqueous dye with respect to a total amount of the textile printing ink composition is 10% by mass or more, and the liquid ejecting head includes the nozzle that ejects the textile printing ink composition, a pressure chamber to which the textile printing ink composition is supplied, and a circulation channel configured to circulate the textile printing ink composition supplied to the pressure chamber.

In the ink jet recording apparatus, the aqueous dye may be an acidic dye, a reactive dye, or a direct dye.

In the ink jet recording apparatus, the content of the aqueous dye with respect to the total amount of the textile printing ink composition may be 20% by mass or more.

In the ink jet recording apparatus, the aqueous organic solvent may contain a first aqueous organic solvent having a vapor pressure of 1 Pa or more at 20° C. and a second aqueous organic solvent having a vapor pressure of less than 1 Pa at 20° C.

In the ink jet recording apparatus, a mass ratio of a content of the second aqueous organic solvent to a content of the first aqueous organic solvent may be from 0.02 to 2.

In the ink jet recording apparatus, the textile printing ink composition may contain urea.

In the ink jet recording apparatus, a mass ratio of a content of the urea to a content of the aqueous dye may be from 0.1 to 0.3.

In the ink jet recording apparatus, the aqueous dye may be at least one of Acid Blue 138, Acid Blue 290, Acid Violet 54, Acid Orange 116, Reactive Yellow 15, Reactive Red 123, and Reactive Blue 222.

An ink jet method according to an aspect of the present disclosure is an ink jet method using the above-described ink jet recording apparatus, the method including an ejecting step of ejecting a textile printing ink composition with a liquid ejecting head to thereby cause the textile printing ink composition to adhere to a recording medium, wherein the textile printing ink composition contains an aqueous dye, an aqueous organic solvent, and water, a content of the aqueous dye with respect to a total amount of the textile printing ink composition is 10% by mass or more, and the liquid ejecting head includes the nozzle that ejects the textile printing ink composition, a pressure chamber to which the textile printing ink composition is supplied, and a circulation channel configured to circulate the textile printing ink composition supplied to the pressure chamber.

### BRIEF DESCRIPTION OF THE DRAWINGS

FIG. 1 is a schematic view for illustrating the structure of a liquid ejecting head usable in the present embodiment.

FIG. 2 is a perspective view of an ink jet recording apparatus based on a serial method according to the present embodiment.

### DESCRIPTION OF EXEMPLARY EMBODIMENTS

Hereafter, an embodiment of the present disclosure (hereafter referred to as “present embodiment”) will be described in detail with reference to the drawings as needed; however, the present disclosure is not limited thereto and various modifications can be made within the scope that does not depart from the spirit of the present disclosure. In the drawings, the same references are applied to the same elements and redundant description is omitted. A positional relationship such as an up-down or a right-left relationship is based on the positional relationship illustrated in the drawings unless otherwise indicated. Dimensional ratios in the drawings are not limited to the ratios illustrated in the drawings.

### 1. Ink Jet Recording Apparatus

An ink jet recording apparatus according to the present embodiment includes a textile printing ink composition and a liquid ejecting head with which the textile printing ink composition is ejected. The liquid ejecting head includes a nozzle that ejects the textile printing ink composition, a pressure chamber to which the textile printing ink composition is supplied; and a circulation channel configured to circulate the textile printing ink composition supplied to the pressure chamber.

The ink jet recording apparatus according to the present embodiment ejects a textile printing ink composition having a relatively large content of an aqueous dye and may include an ink container that contains the textile printing ink composition and an ink channel that links the ink container and the liquid ejecting head. The ink jet recording apparatus according to the present embodiment, with a predetermined liquid ejecting head included therein, is configured to prevent or reduce clogging and maintain recovery from clogging, even when a textile printing ink composition has a relatively large content of an aqueous dye. Thus, using such a textile printing ink composition having a relatively large content of an aqueous dye, recorded articles having high color development properties can be produced.

### 1.1. Liquid Ejecting Head

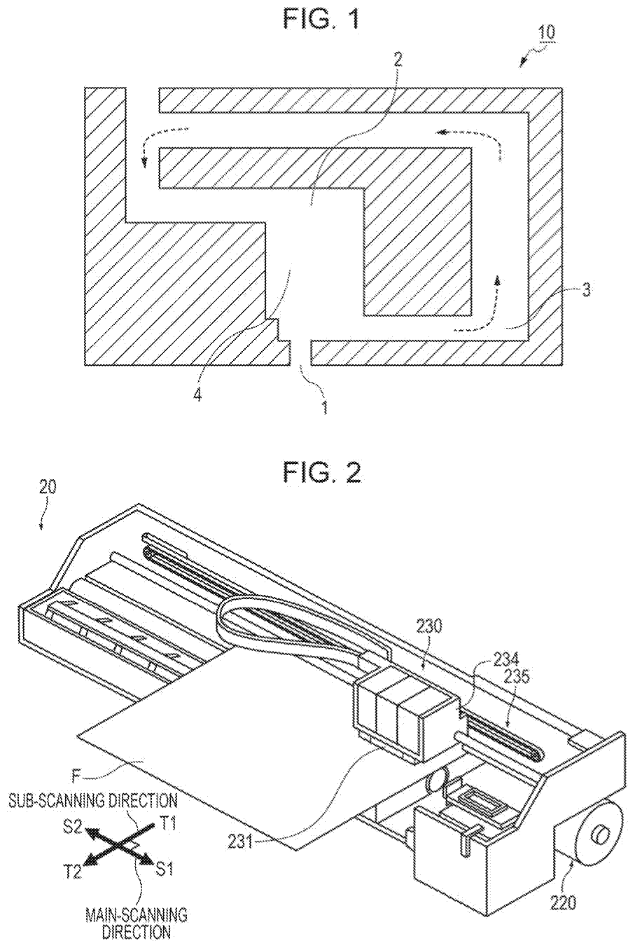

As illustrated in FIG. 1, a liquid ejecting head includes a nozzle 1, a pressure chamber 2 to which the above-described textile printing ink composition is supplied, and a circulation channel 3 configured to circulate the textile printing ink composition supplied to the pressure chamber 2. This enables the textile printing ink composition to circulate in the head, and as a result, the hardening of the ink composition in the vicinity of the nozzle 1 is prevented or reduced. Thus, recorded articles having high color development properties can be obtained.

The liquid ejecting head may include a heating unit that heats the textile printing ink composition in the head. The location where the heating unit is disposed is not particularly limited as long as the heating of the composition in the circulation route including the pressure chamber 2 and the circulation channel 3 is enabled, but, the heating unit may be disposed in, for example, the liquid ejecting head or the ink channel. When a heating unit is disposed in the liquid ejecting head, the heating unit may be disposed in any one of the pressure chamber 2 and the circulation channel 3. The ink jet recording apparatus according to the present embodiment is preferably an ink jet recording apparatus whose ink channel or ink tank is filled with the textile printing ink composition.

FIG. 2 presents a perspective view of a serial printer as an example of the above-described ink jet recording apparatus. As illustrated in FIG. 2, a serial printer 20 includes a transporting unit 220 and a recording unit 230. The transporting unit 220 transports a recording medium F fed into the serial printer 20 to the recording unit 230. The transport unit 220 then discharges the recording medium F after recording is performed to the outside of the serial printer 20. Specifically, the transporting unit 220 includes a passing roller thereof to thereby transport the passed-over recording medium F in the sub-scanning direction T2. The transporting unit 220 may be an endless belt or may include a take-up roller located downstream in the sub-scanning direction T2.

The recording unit 230 includes an ink jet head 231 that ejects the composition onto the recording medium F passed over from the transporting unit 220, a carriage 234 equipped with the ink jet head 231, and a carriage-movement mechanism 235 that moves the carriage 234 in the main-scanning direction S1 or S2 of the recording medium F.

Such a serial printer includes a head serving as the ink jet head 231, the head having a length less than the width of a recording medium. The head moves to thereby perform recording in multiple passes (through multi-pass recording). In such a serial printer, the carriage 234 that moves in a predetermined direction is equipped with the head 231. As a result of the movement of the head 231 accompanying the movement of the carriage 234, the composition is ejected onto the recording medium. Thus, recording is performed in two or more passes (through multi-pass recording). The term “pass” is also referred to as a main scan. Between passes, a sub scan in which the recording medium is transported is performed. That is, a main scan and a sub scan are alternately performed.

The ink jet recording apparatus according to the present embodiment is not limited to a printer based on a serial method such as the above-described printer and may be a printer based on a line method such as the above-described printer.

### 1.2. Textile Printing Ink Composition

The textile printing ink composition contains an aqueous dye, an aqueous organic solvent, and water, and, as needed, may contain urea, a surfactant, a pH adjuster, and other additives.

### 1.2.1. Aqueous Dye

The aqueous dye is not particularly limited, but, for example, may be an acidic dye, a reactive dye, or a direct dye. The dye may be used alone or in a combination of two or more.

The acidic dye is not particularly limited, but examples thereof include C.I. Acid Yellow, C.I. Acid Red, C.I. Acid Blue, C.I. Acid Orange, C.I. Acid Violet, and C.I. Acid Black.

The direct dye is not particularly limited, but examples thereof include C.I. Direct Yellow, C.I. Direct Red, C.I. Direct Blue, C.I. Direct Orange, C.I. Direct Violet, and C.I. Direct Black.

The reactive dye is not particularly limited, but examples thereof include C.I. Reactive Yellow, C.I. Reactive Red, C.I. Reactive Blue, C.I. Reactive Orange, C.I. Reactive Violet, and C.I. Reactive Black.

Among these, as the aqueous dye, at least one of Acid Blue 138, Acid Blue 290, Acid Violet 54, Acid Orange 116, Reactive Yellow 15, Reactive Red 123, and Reactive Blue 222 is preferably used. Aqueous dyes such as these have high wet fastness and relatively low water solubility and thus tend to have poor recovery from clogging. Thus, the present disclosure is particularly useful.

The content of the above-described aqueous dye with respect to the total amount of the textile printing ink composition is b 10% by mass or more, more preferably 12% by mass or more, even more preferably 15% by mass or more, and particularly preferably 20% by mass or more. A preferable lower limit of the content of the aqueous dye may vary depending on the kind of the aqueous dye. In textile printing, a color material penetrates the inside or the reverse side of a fiber. Thus, when the content of the aqueous dye is 10% by mass or more, recorded articles having high color development properties can be produced, and particularly when it comes to a black dye, the achievement of a higher and higher density tends to be desired for an aqueous dye.

With an increased content of an aqueous dye, the content of an aqueous organic solvent and water in the textile printing ink composition is relatively decreased, resulting in proneness to hardening, and as a result, recovery from clogging tends to deteriorate. On the other hand, in the present embodiment, recovery from clogging can be maintained by circulating the textile printing ink composition in the liquid ejecting head with the liquid ejecting head having the above-described structure.

The upper limit of the content of the aqueous dye is not particularly limited, but is preferably 35% by mass or less, more preferably 30% by mass or less, and even more preferably 25% by mass or less with respect to the total amount of the textile printing ink composition. A preferable upper limit of the content of the aqueous dye may vary depending on the kind of the aqueous dye. When the content of the aqueous dye is 35% by mass or less, recovery from clogging tends to be further improved.

### 1.2.2. Aqueous Organic Solvent

The aqueous organic solvent is not particularly limited, but examples thereof include glycerol; lower alcohols such as methanol, ethanol, 1-propanol, isopropanol, 1-butanol, 2-butanol, isobutanol, 2-methyl-2-propanol, 1,3-butanediol, 2-methyl-1,3-propanediol, 3-methyl-1,5-pentanediol, and 1,2-hexanediol; glycols such as ethylene glycol, diethylene glycol, triethylene glycol, tetraethylene glycol, pentaethylene glycol, propylene glycol, dipropylene glycol, and tripropylene glycol; glycol derivatives such as diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; and cyclic amide compounds such as 2-pyrrolidone, N-methyl-2-pyrrolidone, and N-ethyl-2-pyrrolidone. The aqueous organic solvent may be used alone or in a combination of two or more.

The content of the aqueous organic solvent with respect to the total amount of the textile printing ink composition is preferably from 15% to 60% by mass, more preferably from 20% to 55% by mass, and even more preferably from 25% to 50% by mass. When the content of the aqueous organic solvent is 15% by mass or more, an aqueous dye having relatively low water solubility can be dissolved, and as a result, a textile printing ink composition containing a high-density dye tends to be obtained. When the content of the aqueous organic solvent is 60% by mass or less, an abrupt increase in viscosity due to water volatilization can be prevented or reduced, and as a result, recovery from clogging tends to be further improved.

Among these, the aqueous organic solvent preferably contains a first aqueous organic solvent having a vapor pressure of 1 Pa or more at 20° C. and a second aqueous organic solvent having a vapor pressure of less than 1 Pa at 20° C. Because the first aqueous organic solvent has low viscosity, with the first aqueous organic solvent, the fluidity of the textile printing ink composition is further improved, and as a result, recovery from clogging tends to be further improved. Because the second aqueous organic solvent has low volatility, with the second aqueous organic solvent, the fluidity of the textile printing ink composition is further improved, and as a result, recovery from clogging tends to be further improved.

The first aqueous organic solvent is not particularly limited, but examples thereof include propylene glycol, diethylene glycol, 1,2-hexanediol, 1,3-butanediol, diethylene glycol monobutyl ether, 2-methyl-1,3-propanediol, and 2-pyrrolidone. The first aqueous organic solvent may be used alone or in a combination of two or more.

The content of the first aqueous organic solvent with respect to the total amount of the textile printing ink composition is preferably from 7% to 45% by mass, more preferably from 10% to 40% by mass, and even more preferably from 10% to 30% by mass. When the content of the first aqueous organic solvent is in this range, recovery from clogging tends to be further improved.

The second aqueous organic solvent is not particularly limited, but examples thereof include glycerol, triethylene glycol, 3-methyl-1,5-pentanediol, and triethylene glycol monobutyl ether. The second aqueous organic solvent may be used alone or in a combination of two or more.

The content of the second aqueous organic solvent with respect to the total amount of the textile printing ink composition is preferably from 0.1% to 40% by mass, more preferably from 5% to 35% by mass, and even more preferably from 10% to 30% by mass. When the content of the second aqueous organic solvent is in this range, recovery from clogging tends to be further improved.

The mass ratio of the content of the second aqueous organic solvent to the content of the first aqueous organic solvent is from 0.01 to 2.5, more preferably from 0.02 to 2, and even more preferably from 0.5 to 2. When an ink having a tiny amount of moisture evaporating from the nozzle unit is circulated, an abrupt increase in the viscosity of the textile printing ink composition occurs, and as a result, recovery from clogging may be negatively affected. However, when the ratio of the content of the second aqueous organic solvent to the content of the first aqueous organic solvent is in the above-described range, such an increase in viscosity can be prevented or reduced, and as a result, recovery from clogging tends to be further improved.

### 1.2.3. Water

The content of water with respect to the total amount of the textile printing ink composition is preferably from 15% to 75% by mass, more preferably from 20% to 70% by mass. When the content of water is in this range, recovery from clogging tends to be further improved.

### 1.2.4. Urea

The textile printing ink composition preferably contains urea. When urea is contained, the wettability of the textile printing ink composition is improved, and as a result, recovery from clogging tends to be further improved.

The content of urea with respect to the total amount of the textile printing ink composition is preferably from 0.5% to 15% by mass, more preferably from 1% to 12.5% by mass. When the content of urea is in this range, recovery from clogging tends to be further improved.

The mass ratio of the content of urea to the content of the aqueous dye is preferably from 0.05 to 1.0, more preferably from 0.1 to 0.5, and even more preferably from 0.1 to 0.3. When the ratio of the content of urea to the content of the aqueous dye is in this range, the wettability of the textile printing ink composition is further improved, and as a result, recovery from clogging tends to be further improved.

### 1.2.5. Surfactant

The surfactant is not particularly limited, but examples thereof include acetylene glycol surfactants, fluorosurfactants, and silicone surfactants.

The acetylene glycol surfactants are not particularly limited, but examples thereof include 2,4,7,9-tetramethyl-5-decyne-4,7-diol and alkylene oxide adducts of 2,4,7,9-tetramethyl-5-decyne-4,7-diol, and 2,4-dimethyl-5-decyn-4-ol and alkylene oxide adducts of 2,4-dimethyl-5-decyn-4-ol.

The fluorosurfactants are not particularly limited, but examples thereof include perfluoroalkylsulfonic acid salts, perfluoroalkylcarboxylic acid salts, perfluoroalkylphosphoric acid esters, perfluoroalkylethylene oxide adducts, perfluoroalkyl betaines, and perfluoroalkylamine oxide compounds.

Examples of the silicone surfactants include polysiloxane compounds, polyester-modified silicones, and polyether-modified organosiloxanes. Examples of the polyester-modified silicones include BYK-347, 348, BYK-UV3500, 3510, and 3530 (all the foregoing, manufactured by BYK Additives and Instruments GmbH) and an example of the polyether-modified silicones includes BYK-3570 (BYK Additives and Instruments GmbH).

Among the above, acetylene glycol surfactants are preferable. When such a surfactant is used, recovery from clogging tends to be further improved.

The content of the above-described surfactant with respect to the total amount of the textile printing ink composition is preferably from 0.1% to 1% by mass, more preferably from 0.2% to 0.8% by mass. When the content of the surfactant is in this range, recovery from clogging tends to be further improved.

### 1.2.6. pH Adjuster

The pH adjuster is not particularly limited, but examples thereof include alkali metal hydroxides such as lithium hydroxide, potassium hydroxide, and sodium hydroxide; amines such as ammonia, triethanolamine, tripropanolamine, diethanolamine, and monoethanolamine; and carboxylic acids such as adipic acid and citric acid. These pH adjusters are used alone or in a combination of two or more.

The content of the above-described pH adjuster with respect to the total amount of the textile printing ink composition is preferably from 0.1% to 1% by mass, more preferably from 0.2% to 0.8% by mass.

### 2. Ink Jet Method

An ink jet method according to the present embodiment is an ink jet method using the above-described ink jet recording apparatus and includes an ejecting step of ejecting the above-described textile printing ink composition with a liquid ejecting head to thereby cause the textile printing ink composition to adhere to a recording medium

2.1. Ejecting Step

In the ejecting step, the textile printing ink composition is ejected from the liquid ejecting head to thereby cause the textile printing ink composition to adhere to a recording medium. More specifically, a pressure generator is driven such that the composition filled into a pressure chamber of the liquid ejecting head is ejected from a nozzle. This ejecting method is also referred to as an ink jet method.

The liquid ejecting head used in the present embodiment is now described. FIG. 1 presents a schematic view for illustrating the structure of a liquid ejecting head 10. That is, FIG. 1 presents a scheme of a nozzle 1 that ejects the textile printing ink composition, a pressure chamber 2 to which the textile printing ink composition is supplied, and a circulation channel 3 configured to circulate the textile printing ink composition supplied to the pressure chamber 2. In the example of FIG. 1, the nozzle 1 and the pressure chamber are communicated with one another via a communication passage 4.

The nozzle 1 is a through hole through which the textile printing ink composition is ejected. More specifically, the nozzle 1 is a through hole formed in a nozzle plate. In the nozzle plate, a plurality of nozzles are formed, and these nozzles are individually equipped with a pressure chamber 2. The pressure chamber 2 is formed individually per nozzle 1. The textile printing ink composition is supplied to the pressure chamber 2. When the pressure in the pressure chamber 2 is changed by the pressure generator (not illustrated), a portion of the composition that flows inside the communication passage 4 is ejected from the nozzle 1 to the outside and a portion of the remainder flows into the circulation channel 3.

The route of the circulation channel 3 is not particularly limited, but the channel can be structured such that the composition flowing into the circulation channel 3 is supplied to the pressure chamber 2. The composition flowing into the circulation channel 3 is not necessarily required to be re-supplied to the same pressure chamber and may be supplied to another pressure chamber corresponding to another nozzle. In the circulation channel 3, not all channels are required to be inside the liquid ejecting head 10. As long as it is structured such that the composition flowing out from the pressure chamber 2 is re-supplied to the pressure chamber 2, some of the channels may be located outside of the liquid ejecting head 10.

Thus, with the liquid ejecting head 10 according to the present embodiment, the composition in the pressure chamber 2, more specifically, the composition in the vicinity of the nozzle 1 can be circulated efficiently in the head. Thus, even when individual nozzles differ in the usage rate and the nozzle position, clogging of the individual nozzles due to the composition can be prevented or reduced.

The liquid ejecting head 10 used in the ejecting step, is, for example, a line head that performs recording based on a line method or a serial head that performs recording based on a serial method.

In a line method using a line head, for example, a liquid ejecting head having a width equal to or more than the recording width of a recording medium is fixed to the ink jet recording apparatus. The recording medium is then caused to move in the sub-scanning direction (the vertical direction, namely, the transport direction, of the recording medium), and by ejecting ink drops from the nozzle of the liquid ejecting head in conjunction with this movement, an image is recorded on the recording medium.

In a serial method using a serial head, for example, a carriage movable in the direction of the width of a recording medium is equipped with a liquid ejecting head. The carriage is then caused to move in the main-scanning direction (the horizontal direction, namely, the width direction, of the recording medium) and by ejecting ink drops from the nozzle opening of the head in conjunction with this movement, an image can be recorded on the recording medium.

### 2.2. First Heating Step

The ink jet method according to the present embodiment may include a first heating step of heating the composition in the liquid ejecting head 10. More specifically, the method may include a heating step of heating the composition in the circulation route including the pressure chamber 2, the circulation channel 3, and the communication passage 4. The heater is not particularly limited, but, for example, can be disposed in the pressure chamber 2, the circulation channel 3, or the communication passage 4. In addition, a heater that heats the nozzle plate may be disposed, and when the circulation route 3 extends through the outside of the liquid ejecting head 10, a heater may be disposed in the circulation route 3 that is present outside of the liquid ejecting head 10. A heater may be disposed in an ink channel located further upstream than the pressure chamber 2. The term “ink channel” as used herein refers to a channel through which an ink is caused to flow. The ink channel also refers to, for example, an ink supply route that supplies an ink from an ink container in which the ink is stored to an ink jet recording head.

In the heating step, the composition is preferably heated to 40° C. or more. The heating temperature for the composition is more preferably from 40° C. to 60° C., even more preferably from 40° C. to 50° C. Through such a heating step combined with the liquid ejecting head in which the composition is circulated, clogging due to the textile printing ink composition can be prevented or reduced.

### 2.3. Second Heating Step

The ink jet method according to the present embodiment may further include, after the ejecting step, a second heating step of heating the recording medium having the textile printing ink composition adhering thereto. By performing such heating, the moisture and the solvent content in the adhering textile printing ink composition can be evaporated. As a result, flaws are preventable, such flaws including the adhering textile printing ink composition being transferred to the reverse side or the non-adhesion portion of the recording medium when the recording medium is taken up or stacked on top of another recording medium.

### 2.4. Fixing Step

In the ink jet method according to the present embodiment, to fix the dye adhering to the recording medium, a fixing step (steaming step) is preferably performed, after the above-described step or steps, by exposing the recording medium to water vapor in a high-temperature environment. The suitable temperature range slightly differs depending on the kind of the fabric used and the kind of the dye used, but the temperature is preferably in the range of about from 100° C. to 110° C. The exposure time is about from 10 to 20 minutes for a cellulose fiber such as cotton or viscose rayon and about from 20 to 40 minutes for an amide fiber such as silk, wool, or nylon. When the fixing treatment is performed in the above-described ranges, the dye can be well fixed to a fiber.

### 2.5. Washing Step

In the ink jet method according to the present embodiment, after the fixing step, performing washing of the recording medium followed by performing drying is preferable. The specific procedures include (1) water washing (at a normal temperature), (2) hot-water washing, (3) soaping, and (4) drying, but regarding (1) and (2), a selection therebetween may be made. Here, (1) to (3) are intended to sufficiently wash off any unfixed dye, and thus, desirably, the individual procedures are performed for about several minutes. The temperature of the hot water used in (2) is preferably from 40° C. to 60° C.

Here, (3) soaping refers to a step in which stirring together with a washing aid is performed in a hot water bath. The hot-water temperature depends on the kind of the dye used, and is, desirably, from 40° C. to 70° C. when an acidic dye or a direct dye is used and from 80° C. to 100° C. when a reactive dye is used. As the washing aid used, commercially available washing aids are widely usable, and specific examples thereof include ESKUDO M-200, ESKUDO RZ-30 (manufacture by Nicca Chemical Co., Ltd.), LACCOL STA, LACCOL ISF, MEISANOL KHM (manufactured by Meisei Chemical Works, Ltd.), Queen Soap NW-1570, Queen Soap SHA-50, Queen Soap SK-D (manufactured by Kotani Chemical Industry Co., Ltd.), ANIZOL 300, NONIZOL 501 (manufactured by Satoda Chemical Industrial Co., Ltd.), SENKANOL C-80, SENKANOL CW, and SENKANOL GNW (manufactured by Senka Corporation).

In (4) drying, a desired method can be used within the scope that does not impair an aspect of the recording medium, examples of the method including warm-air drying in which warm air or hot air is blown onto the recording medium or the recording medium is exposed to warm air or hot air and press-drying in which heat pressing is performed with an iron or a hot press machine.

### 2.6. Recording Medium

The recording medium is not particularly limited, but, for example, a fabric is usable. The fabric is not particularly limited, but examples thereof include natural fibers or synthetic fibers such as silk, cotton, wool, nylon and rayon.

### EXAMPLES

Hereafter, the present disclosure will be described in further detail with reference to Examples and Comparative Examples. The following Examples are not intended to limit the present disclosure.

### 1. Preparation of Ink Jet Composition

Each component was fed into a mixture tank which was a stainless container to achieve the compositions presented in Tables 1 and 2, and mix-stirring and complete dissolution were performed. Further mix-stirring was then performed at a normal temperature for 1 hour. Subsequently, filtration was performed with a membrane filter of 5 μm to thereby obtain a textile printing ink composition of each Example. Numerical values of components presented in each Example in the Tables are on a % by mass basis unless otherwise indicated.

TABLE 1

| | | | Vapor pressure at | Examples | | | | | | | | |
|---|---|---|---|---|---|---|---|---|---|---|---|---|
| | | | 20° C. (Pa) | A1 | B1 | C1 | D1 | E1 | F1 | G1 | H1 | I1 |
| Aqueous dye | | Acid Black 172 | — | 16 | | | | | | | 16 | |
| | | Acid Red 249 | — | | | | 13 | 13 | | | | |
| | | Acid Yellow 79 | — | | 12 | | | | | | | |
| | | Acid Blue 140 | — | | | 14 | | | | | | |
| | | Direct Blue 199 | — | | | | | | 12 | 12 | | |
| | | Acid Orange 33 | — | | | | | | | | | 15 |
| | | Direct Orange 26 | — | | | | | | | | | |
| | | Acid Red 138 | — | | | | | | | | | |
| | | Acid Violet 54 | — | | | | | | | | | |
| | | Acid Orange 116 | — | | | | | | | | | |
| | | Acid Blue 290 | — | | | | | | | | | |
| Solution A | First | Propylene glycol | 11 | 2 | 4 | | | | | | 2 | |
| | aqueous | Diethylene glycol | 2.7 | | | | 8 | 8 | | | | 5 |
| | organic | 1,2-Hexanediol | 2.5 | | | | 3 | 3 | | | | |
| | solvent | 1,3-Butanediol | 8 | | | | | | 6 | 5 | | |
| | | Diethylene glycol monobutyl ether | 3 | | | | 3 | 3 | | | | |
| | | 2-Methyl-1,3-propanediol | 2.7 | | | | | | | | | 3.5 |
| | | 2-Pyrrolidone | 4 | 11 | 22 | | 5 | 5 | 3 | 3 | 11 | 2 |
| | pH adjuster | Triethanolamine | 1.3 | 0.5 | 0.5 | | 0.6 | 0.6 | | | 0.5 | 0.8 |
| | surfactant | SURFYNOL 465 | 19 | 0.2 | 0.5 | | 0.4 | 0.4 | | | 0.2 | 0.2 |
| Solution B | Second | Glycerol | <0.1 | 5.5 | | 11 | | | 8 | 8 | 5.5 | 8 |
| | aqueous | Triethylene glycol | <0.1 | 3 | | 6 | | | 3 | 3 | 3 | |
| | organic | 3-Methyl-1,5-pentanediol | <0.1 | | | | | | | | | 4 |
| | solvent | Triethylene glycol monobutyl ether | 0.3 | 5 | | 10 | 0.1 | 0.3 | 6.5 | 8.5 | 5 | 4 |
| | pH adjuster | Triisopropanolamine | <0.1 | | | 0.5 | | | 0.3 | 0.3 | | |
| | surfactant | SURFYNOL 104H | 0.7 | 0.2 | | 0.2 | 0.1 | 0.1 | 0.2 | 0.2 | 0.2 | 0.1 |

| | | | | | | | | | | |
|---|---|---|---|---|---|---|---|---|---|---|
| Urea | — | 4.8 | | | | | | | | 0.6 |
| Water | — | 51.8 | 61 | 58.3 | 66.8 | 66.6 | 61 | 60 | 56.6 | 56.8 |
| Content of aqueous organic solvent | — | 26.5 | 26 | 27 | 19.1 | 19.3 | 26.5 | 27.5 | 26.5 | 26.5 |
| Ratio of content of Solution B to content of Solution A | — | 1.00 | — | — | 0.01 | 0.02 | 2.00 | 2.50 | 1.00 | 1.40 |
| Ratio of content of second aqueous organic solvent to content | — | 1.04 | — | — | 0.01 | 0.02 | 1.94 | 2.44 | 1.04 | 1.52 |
| of first aqueous organic solvent | | | | | | | | | | |
| Ratio of content of urea to content of aqueous dye | — | 0.30 | — | — | — | — | — | — | — | 0.04 |

| | | | | | | | | | | Comparative | | | |
|---|---|---|---|---|---|---|---|---|---|---|---|---|---|
| | | | Examples | | | | | | | Examples | | | |
| | | | J1 | K1 | L1 | M1 | N1 | O1 | P1 | A2 | B2 | F2 | M2 |
| Aqueous dye | | Acid Black 172 | | | | | | | | 8 | | | |
| | | Acid Red 249 | | | | | | | | | | | |
| | | Acid Yellow 79 | | | | | | | | | 6 | | |
| | | Acid Blue 140 | | | | | | | | | | | |
| | | Direct Blue 199 | | | | | | | | | | 6 | |
| | | Acid Orange 33 | 15 | | | | | | | | | | |
| | | Direct Orange 26 | | 10 | 10 | | | | | | | | |
| | | Acid Red 138 | | | | 10 | | | | | | | 2 |
| | | Acid Violet 54 | | | | | 10 | | | | | | |
| | | Acid Orange 116 | | | | | | 10 | | | | | |
| | | Acid Blue 290 | | | | | | | 10 | | | | |
| Solution A | First | Propylene glycol | | 2.5 | 2.5 | | | | | 2 | 4 | | |
| | aqueous | Diethylene glycol | 5 | | | | | 20 | | | | | |
| | organic | 1,2-Hexanediol | | 5 | 5 | | 10 | | 20 | | | | |
| | solvent | 1,3-Butanediol | | | | | | | | | | 6 | |
| | | Diethylene glycol monobutyl ether | | | | | | | | | | | |
| | | 2-Methyl-1,3-propanediol | 3.5 | 7 | 7 | | | | | | | | |
| | | 2-Pyrrolidone | 2 | | | 20 | 11 | 20 | 20 | 11 | 22 | 3 | 20 |
| | pH adjuster | Triethanolamine | 0.8 | | | 0.5 | 0.5 | | | 0.5 | 0.5 | | 0.5 |
| | surfactant | SURFYNOL 465 | 0.2 | 1 | 1 | 1 | 0.2 | | | 0.2 | 0.5 | | 1 |
| Solution B | Second | Glycerol | 8 | | | 5 | 15 | | | 5.5 | | 8 | 5 |
| | aqueous | Triethylene glycol | | 12 | 12 | 15 | 5 | | | 3 | | 3 | 15 |
| | organic | 3-Methyl-1,5-pentanediol | 4 | | | | | | | | | | |
| | solvent | Triethylene glycol monobutyl ether | 4 | | | 15 | 10 | 20 | 15 | 5 | | 6.5 | 15 |
| | pH adjuster | Triisopropanolamine | | 0.4 | 0.4 | | | 1 | 1 | | | 0.3 | |
| | surfactant | SURFYNOL 104H | 0.1 | | | 0.3 | 0.3 | 0.5 | 0.5 | 0.2 | | 0.2 | 0.3 |

| | | | | | | | | | | | |
|---|---|---|---|---|---|---|---|---|---|---|---|
| Urea | 1.5 | 6 | 10 | 2 | 3 | 1 | 1 | 4.8 | | | 2 |
| Water | 55.9 | 56.1 | 52.1 | 31.2 | 35 | 27.5 | 32.5 | 59.8 | 67 | 67 | 39.2 |
| Content of aqueous organic solvent | 26.5 | 26.5 | 26.5 | 55 | 51 | 60 | 55 | 26.5 | 26 | 26.5 | 55 |
| Ratio of content of Solution B to content of Solution A | 1.40 | 0.80 | 0.80 | 1.64 | 1.40 | 0.54 | 0.41 | 1.00 | — | 2.00 | 1.64 |
| Ratio of content of second aqueous organic solvent to content | 1.52 | 0.83 | 0.83 | 1.75 | 1.43 | 0.50 | 0.38 | 1.04 | — | 1.94 | 1.75 |
| of first aqueous organic solvent | | | | | | | | | | | |
| Ratio of content of urea to content of aqueous dye | 0.10 | 0.60 | 1.00 | 0.20 | 0.30 | 0.10 | 0.10 | 0.60 | — | — | 1.00 |

TABLE 2

| | | | Vapor pressure at | Examples | | | | | | | |
|---|---|---|---|---|---|---|---|---|---|---|---|
| | | | 20° C. (Pa) | A3 | B3 | C3 | D3 | E3 | F3 | G3 | H3 |
| Aqueous dye | | Reactive Black 39 | | 24 | | | | | | | 24 |
| | | Reactive Black 5 | | | | 21 | | | | | |
| | | Reactive Yellow 95 | | | 23 | | | | | | |
| | | Reactive Red 31 | | | | | 22 | 22 | | | |
| | | Reactive Red 3:1 | | | | | | | 22 | 22 | |
| | | Reactive Blue 49 | | | | | | | | | |
| | | Reactive Orange 13 | | | | | | | | | |
| | | Reactive Yellow 15 | | | | | | | | | |
| | | Reactive Red 123 | | | | | | | | | |
| | | Reactive Blue 222 | | | | | | | | | |
| Solution A | First | Propylene glycol | 11 | 5 | 5 | | | | 2 | 2 | 5 |
| | aqueous | Diethylene glycol | 2.7 | 10 | 9 | | 10 | 10 | | | 10 |
| | organic | 1,2-Hexanediol | 2.5 | | | | 5 | 5 | | | |
| | solvent | 1,3-Butanediol | 8 | | | | 7 | 7 | | | |
| | | Diethylene glycol monobutyl ether | 3 | | | | | | 2.6 | 1.2 | |
| | | 2-Methyl-1,3-propanediol | 2.7 | | | | 3 | 3 | | | |
| | | 2-Pyrrolidone | 4 | 7.5 | 7.5 | | 5 | 5 | 4 | 4 | 7.5 |
| | pH adjuster | Triethanolamine | 1.3 | | 1 | | | | | | |
| | surfactant | SURFYNOL 465 | 19 | | 0.9 | | | | | | |
| Solution B | Second | Glycerol | <0.1 | | | 10 | | | 5 | 5 | |
| | aqueous | Triethylene glycol | <0.1 | | | | | | 5 | 5 | |
| | organic | 3-Methyl-1,5-pentanediol | <0.1 | | | | | 0.3 | | | |
| | solvent | Triethylene glycol monobutyl ether | 0.3 | | | 12.5 | | | 6 | 6.8 | |
| | pH adjuster | Triisopropanolamine | <0.1 | 0.7 | | 0.7 | 0.2 | 0.2 | 1 | 1 | 0.7 |
| | surfactant | SURFYNOL 104H | 0.7 | 0.2 | | 0.2 | 0.1 | 0.1 | 0.2 | 0.2 | 0.2 |

| | | | | | | |
|---|---|---|---|---|---|---|
| pH adjuster | Adipic acid | 0.05 | | 0.06 | 0.06 | 0.05 |
| | Citric acid | | 0.05 | | | |

| | | | | | | | | | |
|---|---|---|---|---|---|---|---|---|---|
| Urea | | 6 | | | | | | | |
| Water | | 46.55 | 53.6 | 55.55 | 47.7 | 47.4 | 52.14 | 52.74 | 52.55 |
| Content of aqueous organic solvent | | 22.5 | 21.5 | 22.5 | 30 | 30.3 | 24.6 | 24 | 22.5 |
| Ratio of content of Solution B to content of Solution A | | 0.04 | — | — | 0.01 | 0.02 | 2.00 | 2.50 | 0.04 |
| Ratio of content of second aqueous organic solvent to content of first | — | — | — | — | — | 0.01 | 1.86 | 2.33 | — |
| aqueous organic solvent | | | | | | | | | |
| Ratio of content of urea to content of aqueous dye | | 0.25 | — | — | — | — | — | — | — |

| | |
|---|---|
| Examples | Comparative Examples |

| | | | I3 | J3 | K3 | L3 | M3 | N3 | O3 | A4 | B4 | F4 | O4 |
|---|---|---|---|---|---|---|---|---|---|---|---|---|---|
| Aqueous dye | | Reactive Black 39 | | | | | | | | 8 | | | |
| | | Reactive Black 5 | | | | | | | | | | | |
| | | Reactive Yellow 95 | | | | | | | | | 7.7 | | |
| | | Reactive Red 31 | | | | | | | | | | | |
| | | Reactive Red 3:1 | | | | | | | | | | 7.3 | |
| | | Reactive Blue 49 | 25 | 25 | | | | | | | | | |
| | | Reactive Orange 13 | | | 20 | 20 | | | | | | | |
| | | Reactive Yellow 15 | | | | | 20 | | | | | | |
| | | Reactive Red 123 | | | | | | 20 | | | | | |
| | | Reactive Blue 222 | | | | | | | 20 | | | | 6.7 |
| Solution A | First | Propylene glycol | 6 | 6 | | | | | | 5 | 5 | 2 | |
| | aqueous | Diethylene glycol | | | 10 | 10 | | | | 10 | 9 | | |
| | organic | 1,2-Hexanediol | 5 | 5 | | | | 20 | | | | | |
| | solvent | 1,3-Butanediol | | | 1.5 | 1.5 | 20 | | 20 | | | | 20 |
| | | Diethylene glycol monobutyl ether | 5 | 5 | | | | 15 | | | | 2.6 | |
| | | 2-Methyl-1,3-propanediol | | | 10 | 10 | | | | | | | |
| | | 2-Pyrrolidone | 10 | 10 | | | 20 | | 15 | 7.5 | 7.5 | 4 | 15 |
| | pH adjuster | Triethanolamine | | | 0.5 | 0.5 | 0.5 | | | | 1 | | |
| | surfactant | SURFYNOL 465 | | | | | | | | | 0.9 | | |
| Solution B | Second | Glycerol | | | | | | | | | | 5 | |
| | aqueous | Triethylene glycol | 2 | 2 | | | | | | | | 5 | |
| | organic | 3-Methyl-1,5-pentanediol | | | 1 | 1 | | | 15 | | | | 15 |
| | solvent | Triethylene glycol monobutyl ether | | | | | 20 | 15 | | | | 6 | |
| | pH adjuster | Triisopropanolamine | 0.5 | 0.5 | | | | 0.5 | 1 | 0.7 | | 1 | 1 |
| | surfactant | SURFYNOL 104H | 0.1 | 0.1 | 0.1 | 0.1 | 0.1 | 0.1 | 0.5 | 0.2 | | 0.2 | 0.5 |

| | | | | | |
|---|---|---|---|---|---|
| pH adjuster | Adipic acid | | | 0.05 | 0.06 |
| | Citric acid | 0.03 | 0.03 | | |

| | | | | | | | | | | | |
|---|---|---|---|---|---|---|---|---|---|---|---|
| Urea | 1 | 2.5 | 6 | 10 | 3 | 3 | 3 | 6 | | | 3 |
| Water | 45.37 | 43.87 | 50.9 | 46.9 | 16.4 | 26.4 | 25.5 | 62.55 | 68.9 | 66.84 | 38.8 |
| Content of aqueous organic solvent | 28 | 28 | 22.5 | 22.5 | 60 | 50 | 50 | 22.5 | 21.5 | 24.6 | 50 |
| Ratio of content of Solution B to content of Solution A | 0.10 | 0.10 | 0.05 | 0.05 | 0.50 | 0.45 | 0.47 | 0.04 | — | 2.00 | 0.47 |
| Ratio of content of second aqueous organic solvent to content of first | 0.08 | 0.08 | 0.05 | 0.05 | 0.50 | 0.43 | 0.43 | — | — | 1.86 | 0.43 |
| aqueous organic solvent | | | | | | | | | | | |
| Ratio of content of urea to content of aqueous dye | 0.04 | 0.10 | 0.30 | 0.50 | 0.15 | 0.15 | 0.15 | 0.75 | — | — | 0.45 |

### Aqueous Dye

Acid Black 172

Acid Red 249

Acid Yellow 79

Acid Blue 140

Direct Blue 199

Acid Orange 33

Direct Orange 26

Acid Red 138

Acid Violet 54

Acid Orange 116

Acid Blue 290

Reactive Black 39

Reactive Black 5

Reactive Yellow 95

Reactive Red 31

Reactive Red 3:1

Reactive Blue 49

Reactive Orange 13

Reactive Yellow 15

Reactive Red 123

Reactive Blue 222

### Aqueous Organic Solvent

Propylene glycol

Diethylene glycol

1,2-Hexanediol

1,3-Butanediol

Diethylene glycol monobutyl ether

2-Methyl-1,3-propanediol

2-Pyrrolidone

Glycerol

Triethylene glycol

3-Methyl-1,5-pentanediol

Triethylene glycol monobutyl ether

### pH Adjuster

Triethanolamine (TEA)

Triisopropanolamine (TPA)

Adipic acid

Citric acid

### Surfactant

SURFYNOL 465 (acetylene glycol surfactant, manufactured by Nissin Chemical Industry Co., Ltd.)

SURFYNOL 104H (acetylene glycol surfactant, manufactured by Nissin Chemical Industry Co., Ltd.)

### Others

Urea

### 2. Evaluation Method

2.1. Evaluation of Recovery from Clogging

As an ink jet recording apparatus 2, Monna-Lisa EVO T16 180 (manufactured by Robustelli, S.r.l.) was prepared. As an ink jet recording apparatus 1, the ink jet recording apparatus 2 modified to include a liquid ejecting head that included a circulation channel as illustrated in FIG. 1 was prepared. With the ink jet recording apparatus 1 and, separately, with the ink jet recording apparatus 2, under conditions of 23° C. and 50% RH, the textile printing ink composition was continuously ejected for 10 minutes and then left to stand as it was for 1 hour without being subjected to capping or the like.

After being left to stand, the textile printing ink composition was ejected onto photographic paper until normal ejection of the textile printing ink composition from all nozzles was achieved, and the number of the resulting ink drops obtained until normal ejection of the textile printing ink composition was achieved was counted. Based on the count of the ink drops, recovery from clogging was evaluated in accordance with the evaluation criteria below. The ink jet recording apparatus 1 and ink jet recording apparatus 2 were used with the driving voltage of PZT elements being adjusted such that these ink jet recording apparatuses had the same amount of the textile printing ink composition ejected. With up to a “C” evaluation, no practical problem occurs. Table 3 presents the results.

### Evaluation Criteria

S: Normal ejection is achieved with 500 shots or less.
A: Normal ejection is achieved with more than 500 shots and 2000 shots or less.
B: Normal ejection is achieved with more than 2000 shots and 5000 shots or less.
C: Normal ejection is achieved with more than 5000 shots and 10000 shots or less.
D: No normal ejection is achieved with 10000 shots and normal ejection is achieved by performing nozzle cleaning.
E: No normal ejection is achieved with 10000 shots, and even by performing nozzle cleaning, no normal ejection is achieved from some nozzles.
F: No normal ejection is achieved with 10000 shots, and even by performing nozzle cleaning, no normal ejection is achieved from most of the nozzles.

TABLE 3

| | | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|---|
| Recording apparatus 1 | Ink | A1 | B1 | C1 | D1 | E1 | F1 | G1 | H1 | I1 | J1 | K1 | L1 | M1 | N1 | O1 | P1 |
| | Results | S | C | C | C | B | B | C | B | A | S | S | B | B | C | A | B |
| Recording apparatus 2 | Ink | A1 | B1 | C1 | D1 | E1 | F1 | G1 | H1 | I1 | J1 | K1 | L1 | M1 | N1 | O1 | P1 |
| | Results | D | E | D | E | E | D | D | D | D | D | D | D | F | F | F | F |

| | | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| Recording apparatus 1 | Ink | A3 | B3 | C3 | D3 | E3 | F3 | G3 | H3 | I3 | J3 | K3 | L3 | M3 | N3 | O3 |
| | Results | S | C | C | C | B | B | C | B | A | S | S | B | A | C | B |
| Recording apparatus 2 | Ink | A3 | B3 | C3 | D3 | E3 | F3 | G3 | H3 | I3 | J3 | K3 | L3 | M3 | N3 | O3 |
| | Results | D | E | D | E | E | D | D | E | E | E | D | D | F | F | F |

### 2.2. Production of Printing Fabric 1 (ink: A1 to P1, A2, B2, F2, and M2)

With the ink jet recording apparatus 1, solid printing was performed such that an amount of adhesion of the textile printing ink composition to a fabric was 19.3 g/m². As the fabric, a silk fabric (habutae silk, 14 momme, manufactured by Shikizensha Co., Ltd.) treated with a pretreatment liquid containing 1.0% by mass of sodium alginate, 1.0% by mass of guar gum, 4.0% by mass of ammonium sulfate, 10.0% by mass of urea, and water (being the rest) and squeezed and dried with a mangle at a pick-up rate of 20% was used.

After solid printing was performed, steam treatment was performed with a steamer (type-DHe steamer, manufactured by Mathis AG) at 102° C. for 30 minutes. Water washing was then performed to remove any unfixed dye. Subsequently, after hot-water washing (at 40° C. for 10 minutes) was performed, washing was performed with hot water at 55° C. containing 0.2% by mass of LACCOL STA (washing aid, manufactured by Meisei Chemical Works, Ltd.) for 10 minutes, rinsing was performed with water at a normal temperature, and then drying was performed to thereby produce a printing fabric 1.

### 2.3. Production of Printing Fabric 2 (ink: A3 to O3, A4, B4, F4, and O4)

With the ink jet recording apparatus 1, solid printing was performed such that an amount of adhesion of the textile printing ink composition to a fabric was 19.3 g/m². As the fabric, a cotton fabric (with cotton broadcloth sill, manufactured by Shikizensha Co., Ltd.) treated with a pretreatment liquid containing 1.0% by mass of sodium alginate, 1.0% by mass of guar gum, 4.0% by mass of ammonium sulfate, 10.0% by mass of urea, and water (being the rest) and squeezed and dried with a mangle at a pick-up rate of 20% was used.

After solid printing was performed, steam treatment was performed with a steamer (type-DHe steamer, manufactured by Mathis AG) at 102° C. for 12 minutes. Water washing was then performed to remove any unfixed dye. Subsequently, after hot-water washing (at 50° C. for 10 minutes) was performed, washing was performed with hot water at 90° C. containing 0.2% by mass of LACCOL STA (washing aid, manufactured by Meisei Chemical Works, Ltd.) for 10 minutes, rinsing was performed with water at a normal temperature, and then drying was performed to thereby produce a printing fabric 2.

### 2.4. Evaluation of Printing Density

For the printing fabrics 1 and 2 thus obtained, the density (OD value) of the printing fabrics was measured with a spectral densitometer FD-7 (manufactured by Konica Minolta, Inc.). In measurement, a polarizing filter was used according to the colors of color materials, and the values of color regions (Dk, Dc, Dm, and Dy) suitable for the color materials were calculated. The measurement conditions were conditions of a light source of D 65, a viewing angle of 10°, Status-T, and a presence of an UV filter. Table 4 presents the results.

TABLE 4

| | | Examples | | | | Examples | | | |
|---|---|---|---|---|---|---|---|---|---|
| | Ink | A1 | B1 | F1 | M1 | A3 | B3 | F3 | O3 |
| Recording apparatus 1 | OD value | 1.69 | 1.30 | 1.47 | 1.58 | 1.72 | 1.31 | 1.70 | 1.66 |
| | Color region | Dk | Dy | Dc | Dm | Dk | Dy | Dm | Dc |
| | | Comparative Examples | | | | Comparative Examples | | | |
| | Ink | A2 | B2 | F2 | M2 | A4 | B4 | F4 | O4 |
| Recording apparatus 1 | OD value | 1.47 | 1.09 | 1.21 | 1.18 | 1.56 | 1.02 | 1.50 | 1.18 |
| | Color region | Dk | Dy | Dc | Dm | Dk | Dy | Dm | Dc |

### 2.5. Evaluation of Fastness

A fastness test was conducted on the printing fabrics thus obtained in accordance with each of the following standards: washing fastness (JIS L 0844: 2011 A-2), perspiration fastness (JIS L 848: 2004), and water fastness (JIS L 846: 2004). As the standard adjacent fabrics for the test, a silk fabric (No. 2-1) described in JIS L 0803 was used for the inks A1 to P1 and a cotton fabric (No. 3-1) described in JIS L 0803 was used for the inks A3 to O3. The standard adjacent fabrics used were purchased from the Japanese Standards Association. Table 5 presents the results. The numerical values in Table 5 indicate the numerical grade results of each fastness test.

TABLE 5

| Ink | | | A1 | B1 | C1 | D1 | F1 | I1 | K1 | M1 | N1 | O1 | P1 |
|---|---|---|---|---|---|---|---|---|---|---|---|---|---|
| Washing fastness | | Discoloration | 3 | 3/4 | 3/4 | 3/4 | 3/4 | 4 | 2 | 4/5 | 5 | 5 | 4 |
| | | Dye transfer | 3 | 3/4 | 3 | 3 | 4 | 3 | 2 | 4/5 | 5 | 5 | 4/5 |
| Perspiration fastness | Acid | Discoloration | 4 | 3/4 | 3/4 | 4 | 3 | 3/4 | 4 | 5 | 4/5 | 4/5 | 4/5 |
| | | Dye transfer | 3/4 | 4 | 4 | 3/4 | 4 | 3/4 | 4 | 5 | 4/5 | 4/5 | 4 |
| | Alkali | Discoloration | 3/4 | 3/4 | 3/4 | 3/4 | 3 | 3/4 | 3 | 5 | 4/5 | 4/5 | 4/5 |
| | | Dye transfer | 3/4 | 3/4 | 3/4 | 3 | 3 | 3/4 | 3 | 5 | 4/5 | 4/5 | 4 |

| | | | | | | | | | | | | |
|---|---|---|---|---|---|---|---|---|---|---|---|---|
| Water fastness | Dye transfer | 3/4 | 3/4 | 4 | 3 | 4 | 3/4 | 2 | 5 | 4/5 | 5 | 4 |

| Ink | | | A3 | B3 | C3 | D3 | F3 | I3 | K3 | M3 | N3 | O3 |
|---|---|---|---|---|---|---|---|---|---|---|---|---|
| Washing fastness | | Discoloration | 4 | 4 | 4 | 4 | 4 | 4 | 4 | 5 | 5 | 5 |
| | | Dye transfer | 3/4 | 4 | 3/4 | 4 | 4 | 4/5 | 3/4 | 5 | 5 | 5 |
| Perspiration fastness | Acid | Discoloration | 4 | 4 | 4 | 3/4 | 4 | 4 | 4 | 5 | 5 | 5 |
| | | Dye transfer | 3/4 | 4 | 3/4 | 3/4 | 3/4 | 4 | 3/4 | 5 | 5 | 5 |
| | Alkali | Discoloration | 3/4 | 4 | 4 | 4 | 4 | 4 | 4 | 5 | 5 | 5 |
| | | Dye transfer | 3/4 | 4 | 3/4 | 3/4 | 3/4 | 3/4 | 3/4 | 5 | 5 | 5 |

| | | | | | | | | | | | |
|---|---|---|---|---|---|---|---|---|---|---|---|
| Water fastness | Dye transfer | 4 | 4 | 4 | 4 | 4 | 4 | 4 | 5 | 5 | 5 |

2.6. Printing Fabric Production Evaluation of Inks of Comparative Examples with Per-Unit-Area Dye Application Amount Thereof Being Matched with That of Inks of Examples

With the ink jet recording apparatus 1, solid printing was performed using the ink compositions A2, B2, F2, and M2 of Comparative Examples, with the application amount being adjusted such that the per-unit-area dye adhesion amounts of the ink compositions A2, B2, F2, and M2 of Comparative Examples matched those of the ink compositions A1, B1, F1, and M1 of Examples, respectively, to produce printing fabrics.

Specifically, because the ratio of the content of the dye in the inks A2, B2, and F2 to the content of the dye in the inks A1, B1, and F1, respectively, was ½, twofold application was performed at the same location during ejection with an application amount of 19.3 mg/m². Other than this, the same procedures as in the above-described method for producing printing fabrics were performed. Because the ratio of the content of the dye in M2 to the content of the dye in M1 was ⅕, fivefold application was performed at the same location during ejection with an application amount of 19.3 mg/m². Other than this, the same procedures as with A2, B2, and F2 were performed.

The same recording was performed for the ink compositions containing a reactive dye, namely, the ink compositions A3, B3, F3, and O3 of Examples and the ink compositions A4, B4, F4, and O4 of Comparative Examples to produce printing fabrics.

Printing density measurement was performed on each obtained printing fabric and the degree of bleeding on end portions of solid printed sections was determined through visual observation. Based on the results, evaluation was performed in accordance with the evaluation criteria below. Table 6 presents the results.

### Evaluation Criteria

A: No bleeding is present and the contours are very sharp and clear.
B: Some bleeding is present but the contours are recognizable.
C: Color bleeding is present and the contours are blurred and difficult to recognize.
D: Bleeding is severe and the location of the contours is indiscernible.

TABLE 6

| | | Examples | | | | Examples | | | |
|---|---|---|---|---|---|---|---|---|---|
| | Ink | A1 | B1 | F1 | M1 | A3 | B3 | F3 | O3 |
| Recording apparatus 1 | OD value | 1.69 | 1.30 | 1.47 | 1.58 | 1.72 | 1.31 | 1.70 | 1.66 |
| | Color region | Dk | Dy | Dc | Dm | Dk | Dy | Dm | Dc |
| | Bleeding | A | A | A | A | A | A | A | A |

| | | Comparative Examples | | | | | | | |
|---|---|---|---|---|---|---|---|---|---|
| | | | | | Fivefold | Comparative Examples | | | |
| | | Twofold application | | | application | Threefold application | | | |
| | Ink | A2 | B2 | F2 | M2 | A4 | B4 | F4 | O4 |
| Recording apparatus 1 | OD value | 1.60 | 1.22 | 1.43 | 1.48 | 1.63 | 1.22 | 1.55 | 1.32 |
| | Color region | Dk | Dy | Dm | Dc | Dk | Dy | Dm | Dc |
| | Bleeding | C | C | C | D | D | D | D | D |

### 3. Evaluation Results

Tables 1 and 2 present the composition of the textile printing ink compositions used in Examples and Tables 3 to 6 present the evaluation results. These Tables reveal that the recording apparatuses that eject the textile printing ink composition containing a predetermined amount of aqueous dye with a predetermined liquid ejecting head enable excellent recovery from clogging and high-density printing without causing the occurrence of bleeding.

Specifically, Table 3 reveals that when the recording apparatus 1 and the recording apparatus 2 are compared, excellent recovery from clogging is achieved with the recording apparatus 1. On the other hand, although not presented in Table 3, it is also revealed that when the ink compositions of Comparative Examples A2, B2, F2, M2, A4, B4, F4, and O4 are used, neither the recording apparatus 1 nor the recording apparatus 2 has any issues of recovery from clogging and that the issues of recovery from clogging are a problem specific to the textile printing ink compositions containing a predetermined amount of aqueous dye.

Furthermore, as presented in Table 4, the comparison between when the ink compositions of Examples are used and when the ink compositions of Comparative Examples A2, B2, F2, M2, A4, B4, F4, and O4 are used reveals that the optical density (OD value) of the obtained printed articles is poorer when the ink compositions of Comparative Examples are used.

Particularly as presented in Table 6, when twofold or fivefold application is performed with the inks of Comparative Examples to make the optical density (OD value) of the ink compositions of Comparative Examples match that of the ink compositions of Examples, the OD value of the inks of Comparative Examples becomes close to, but does not reach the same level of, the OD value of the inks of Examples. The conceivable reason therefor is that because heavy application of not only the color materials but also the solvent is performed, the color materials penetrate the reverse side of the fabric and thus fail to sufficiently remain on the surface.

As presented in Table 6, when multifold application is performed in Comparative Examples, heavier application of the solvent to the fabric than in Examples is performed. Thus, in the portions where such multifold application was performed, bleeding was severer in the entire printed sections and complete blurring was exhibited particularly on end portions thereof, resulting in a complete breakdown of the boundary portion with non-printed sections.

As presented in Table 5, it was also confirmable that all the printed articles obtained by using the ink compositions of Examples exhibit excellent fastness.

What is claimed is:

1. An ink jet recording apparatus comprising:
a textile printing ink composition; and
a liquid ejecting head including a nozzle that ejects the textile printing ink composition, wherein
the textile printing ink composition contains
an aqueous dye;
an aqueous organic solvent; and
water,
a content of the aqueous dye with respect to a total amount of the textile printing ink composition is 10% by mass or more, and
the liquid ejecting head includes
the nozzle that ejects the textile printing ink composition;
a pressure chamber to which the textile printing ink composition is supplied; and
a circulation channel configured to circulate the textile printing ink composition supplied to the pressure chamber.

2. The ink jet recording apparatus according to claim 1, wherein
the aqueous dye is an acidic dye, a reactive dye, or a direct dye.

3. The ink jet recording apparatus according to claim 1, wherein
the content of the aqueous dye with respect to the total amount of the textile printing ink composition is 20% by mass or more.

4. The ink jet recording apparatus according to claim 1, wherein
the aqueous organic solvent contains
a first aqueous organic solvent having a vapor pressure of 1 Pa or more at 20° C.; and
a second aqueous organic solvent having a vapor pressure of less than 1 Pa at 20° C.

5. The ink jet recording apparatus according to claim 4, wherein
a mass ratio of a content of the second aqueous organic solvent to a content of the first aqueous organic solvent is from 0.02 to 2.

6. The ink jet recording apparatus according to claim 1, wherein
the textile printing ink composition contains urea.

7. The ink jet recording apparatus according to claim 6, wherein
a mass ratio of a content of the urea to a content of the aqueous dye is from 0.1 to 0.3.

8. The ink jet recording apparatus according to claim 1, wherein
the aqueous dye is at least one of Acid Blue 138, Acid Blue 290, Acid Violet 54, Acid Orange 116, Reactive Yellow 15, Reactive Red 123, and Reactive Blue 222.

9. An ink jet method using the ink jet recording apparatus according to claim 1, the method comprising:
an ejecting step of ejecting a textile printing ink composition with a liquid ejecting head to thereby cause the textile printing ink composition to adhere to a recording medium, wherein
the textile printing ink composition contains
an aqueous dye;
an aqueous organic solvent; and
water,
a content of the aqueous dye with respect to a total amount of the textile printing ink composition is 10% by mass or more, and
the liquid ejecting head includes
the nozzle that ejects the textile printing ink composition;
a pressure chamber to which the textile printing ink composition is supplied; and
a circulation channel configured to circulate the textile printing ink composition supplied to the pressure chamber.
